(19) United States
(12) Patent Application Publication
(10) Pub. No.: US 2011/0004742 A1
(43) Pub. Date: Jan. 6, 2011

(54) Variable-Cycle, Event-Driven Multi-Execution Flash Processor

(75) Inventor: Khursheed Hassan, Austin, TX (US)

Correspondence Address: Edward J. Marshall, Attorney at Law, 8705 Shoal Creek Blvd., Suite 202, Austin, TX, 78757, US

(73) Assignee: EONSIL, INC., Austin, TX (US)

(21) Appl. No.: 12/826,949

(22) Filed: Jun. 30, 2010

Related U.S. Application Data
(60) Provisional application No. 61/223,064, filed on Jul. 6, 2009.

(51) Int. Cl. G06F 9/30; G06F 9/312; G06F 12/02

(52) U.S. Cl. 712/205; 712/220; 711/103; 712/208; 711/E12.008; 712/E09.016; 712/E09.033

(57) ABSTRACT

A Multi-Execution Flash Processor core performs operations associated with accessing non-volatile semiconductor based memory units. Execution units included in the core can execute instructions requiring different numbers of clock cycles to complete by generating an event control signal in response to completing an instruction. The core can be used in a controller to access and control external memory units. Data memory access operations include using an instruction decoder to select one or more execution units to perform an operation associated with the instruction, and generating an event control signal upon completion of the operation. In some cases, executing the instruction includes selecting a second execution unit.

### CROSS REFERENCE TO RELATED APPLICATIONS

This application claims priority under 35 U.S.C. §119(e) of U.S. Provisional Patent Application No. 61/223,064, by Hassan, “Method of Using Variable Cycle Execution Units in a Programmable Core,” filed Jul. 6, 2009, which is incorporated by reference for all purposes.

### FIELD

The present disclosure relates generally to processors used to control memory access, and more particularly to solid state non-volatile memory controller cores.

### BACKGROUND

Data memory access within a solid state drive can be controlled by a central processing unit (CPU). However, the CPU must also contend with software that requires much of its time. As a result, the CPU doesn't have as much time to devote to data memory access. Furthermore, the memory access can be somewhat time-consuming for CPUs, as the CPU generally controls single lines of data, and confirms each step of the data operation before continuing, all while having to contend with its own software requirements. The ultimate result is that the time requirements for data memory access controlled directly by the CPU are relatively high.

In some cases, the transfer of data to and from the CPU is accomplished through the use of a second processor referred to as a co-processing unit (CU). However, the GPU generally cannot transfer data directly from the relevant memory device to the CPU; an intermediary device is usually required. Such an intermediary adds to the cost and complexity of the overall drive controller.

Conventional CPUs and GPUs also tend to be limited by the construction of their arithmetic logic units (ALUs), which tend to require instructions having a fixed number of cycles. The fixed number of cycles is appropriate where Instructions per cycle (IPC) needs to be maximized, but implementing some memory access functions based on fixed cycle instructions can be less than ideal.

### SUMMARY

Various aspects of the disclosure provide processor cores with the ability to be programmed to enable operations without being limited by the processing capacity of the central processing unit. The processor cores may be provided with the ability to be reprogrammable and to utilize event control and feedback, which allows execution of instructions without relying on counting the number of clock cycles to determine when an operation or instruction has been completed.

In one aspect of the disclosure, the processor core includes an instruction register unit, an instruction decoder unit, and multiple execution units configured to perform operations associated with accessing non-volatile semiconductor memory units, for example flash drives. The instruction register unit fetches instructions for an operation from an instruction memory, and the instruction decoder unit provides each of the instructions to the execution units. The execution units are configured to execute instructions requiring different numbers of clock cycles to complete, and are capable of generating an event control signal in response to completing execution of an instruction.

In another aspect of the disclosure, a solid state drive controller includes a processor core, a central processing unit, a nonvolatile semiconductor based memory unit, and an interface that couples the processor core with the memory unit. The processor core can be configured to respond to memory access commands issued by the central processing unit or an external source, and to control access to the nonvolatile semiconductor based memory unit. In at least one embodiment, the processor core is configured to be externally event driven, and to execute memory access instructions that require a variable number of clock cycles to complete.

In another aspect of the disclosure, a method of performing a memory access operation comprises the steps of loading into an instruction memory unit a set of instructions, fetching from the instruction memory unit an instruction from the set of instructions, using an instruction decoder unit to select an execution unit to perform some part of an operation associated with the instruction, executing the part of the instruction using the execution unit, and generating an event control signal upon completion of the operation associated with the instruction. Execution of part of the operation by the execution unit may include selecting a second execution unit to execute another part of the instruction.

### BRIEF DESCRIPTION OF THE DRAWINGS

Aspects of this disclosure will become apparent upon reading the following detailed description and upon reference to the accompanying drawings, in which like references may indicate similar elements:

FIG. 1 is a high-level block diagram illustrating a solid state drive controller according to an embodiment of the present disclosure;

FIG. 2 is a high-level block diagram illustrating a Multi-Execution Flash Processor core according to one embodiment of the present disclosure;

FIG. 3 is a high-level block diagram illustrating a Multi-Execution Flash Processor core according to one embodiment of the present disclosure;

FIG. 4 is a high-level block diagram illustrating a Multi-Execution Flash Processor core according to another embodiment of the present disclosure; and

FIG. 5 is a flow chart illustrating a method of executing a data memory access operation according to an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

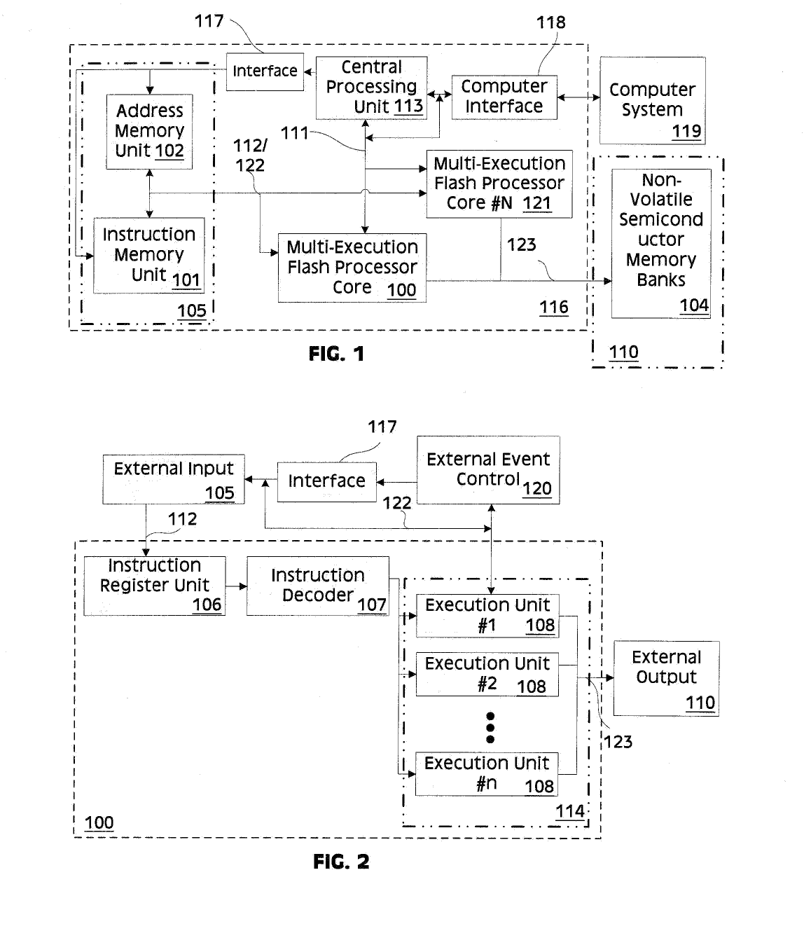

Referring first to FIG. 1, a high-level block diagram of a solid state drive controller is illustrated and discussed. Drive controller 116 includes at least one central processing unit (CPU) 113, an instruction memory unit (IMU) 101, an address memory unit (AMU) 102, a multi-execution flash processor (MXFP) 100, and an external output 110 that can include at least one bank of nonvolatile semiconductor-based memory (NVSM) banks 104, such as NAND flash memory units. The drive controller 116 is configured to allow the CPU 113 to direct the MXFP 100 to perform data memory access operations on the NVSM banks 104, although some embodiments can be configured to allow the MXFP 100 to be controlled by an external source. There can be additional MXFPs 121. Additionally, the drive controller 116 can be configured to allow the CPU 113 to order the MXFP 100 to transmit both atomic and separate commands to the NVSM banks 104.

The IMU 101 can be programmed, both during and after manufacture, to hold instructions in Tightly-Packed Instruction Sets (TPIS) to perform data memory access operations for multiple NVSM banks 104. Each TPIS is an application-specific instruction set that is to be executed by the MXFP 100 to perform the data memory access operation that includes instructions having variably sized opcodes and operands. Furthermore, the amount of the IMU 101 devoted to a TPIS is variable, depending on the operation associated with the instruction. Finally, the TPISs can be combined into programs having action sequences. These action sequences can be stored concurrently within the IMU 101 or transmitted to the NVSM banks 104 though the MXFP 100.

The AMU 102 can be programmed, by the CPU 113 for example, to store the addresses of the NVSM banks 104 that are to be accessed by the data memory access operation. The CPU 113 is configured to communicate with both the IMU 101 and AMU 102 through an interface 117. The CPU 113 can be further configured to communicate with an external computer system 119 by being coupled with a computer interface 118. The CPU 113 can, in some embodiments, utilize an interface 117 to program the AMU 102 with a variable number of addresses of the NVSM banks 104. In addition, the CPU 113 can, in some embodiments, utilize an interface 117 to give the IMU 101 a multiple of TPISs required for ordering the MXFP 100 to perform various data memory access operations on the NVSM banks 104.

The CPU 113 is also coupled to the MXFP 100 through a transmission line 111 that enables the CPU 113 to order the MXFP 100 to fetch instruction and address data from both the IMU 101 and the AMU 102, which together comprise the external source of data input 105, through the transmission line 112 to the MXFP 100 to begin the instructed data memory access operation. In some embodiments, the MXFP 100 can be configured to be controlled by an external source, such as the computer system 119, though an external interface, such as through computer interface 118. Both transmission line 112 and transmission line 122 enable the MXFP 100 to engage in two-way communication with the IMU 101, the AMU 102, while transmission line 111 enables the MXFP 100 to engage in two-way communication with the CPU 113. Such two-way communication ability enables the MXFP 100 to transmit event control signals that provide operational feedback to any of these devices during a data memory access operation. Additional MXFPs 121 would also utilize transmission line 112, transmission line 122, and transmission line 111. Finally, the MXFP 100 is coupled to the external output 110, which can include NVSM banks 104, through a transmission line 123 that enables the MXFP 100 to execute the data memory access operations. The MXFP 100 can also be programmed to work with an external output 110 that includes different numbers of NVSM banks 104. In such a configuration, the MXFP 100 can be programmed to access different numbers of NVSM banks 104 either individually, in a sequence, or simultaneously. Disclosed embodiments are not limited to transmitting signals across transmission lines; signals can also be transmitted over a bus, or using other known signal transmission methods.

As is shown in FIG. 2, the MXFP 100 itself can include several units that interact both with each other and external devices to execute data memory access operations or to transmit action sequences. The instruction register unit (IRU) 106 fetches and receives the opcodes and operands from the instruction sets in the IMU 101 and the addresses in the AMU 102, which together comprise the input 105, through the transmission line 112. The instruction and address operands and opcodes fetched by the IRU 106 are interpreted by the instruction decoder unit (IDU) 107, which selects execution units to perform the operation. Each execution unit 108 is configured in parallel within a bank, or stage, of execution units 114.

This configuration enables the IDU 107 to delegate portions of the overall data memory access operation to individual execution units, enabling the operation to be performed faster than if the operation were performed by a single execution unit. Furthermore, each execution unit 108 is configured to operation on an event basis, independent of a number of clock cycles. Essentially, the execution units can be ordered to operate for as many clock cycles are necessary to complete the operation. If multiple execution units 108 are operating on an event basis simultaneously, they can be ordered to wait, following the completion of their respective operations, until all execution units have finished their respective operations, at which time a single execution unit that has be ordered to track the progress of the other execution units will transmit a signal indicating that all execution units have completed their operations and are ready for either new instructions or new addresses.

The execution units 108 are configured such that an instruction given to an execution unit 108 can control it in many ways. Specifically, the execution unit 108 can be dedicated to a particular instruction, where the instruction's operand can wait for a number of events corresponding to the “external” or “internal” signals. In such a configuration, the execution unit 108 can react differently to different signals, usually by generating an event control signal that is specific to the event detected. For example, an execution unit 108 that is programmed with an instruction that orders the execution unit to detect when all other execution units 108 have completed their respective operations will wait until it detects a specific external signal that indicates that all other execution units have completed their operations, at which time the execution unit 108 will transmit a signal to order the IRU 106 to fetch additional instructions from the IMU 101.

The execution units 108 can also be programmed to operate in parallel with each other. In some embodiments, such an operation can occur in two ways. First, the execution units 108 can operate in series, whereby one execution unit 108, upon completing its operation, can order another execution unit 108 to execute its respective operation. Alternatively, the execution units 108 can operate laterally, whereby some execution units 108 are started by a new instruction while other execution units 108 continue to operate under an older instruction. In this manner, multiple execution units 108 are operating simultaneously under different instructions.

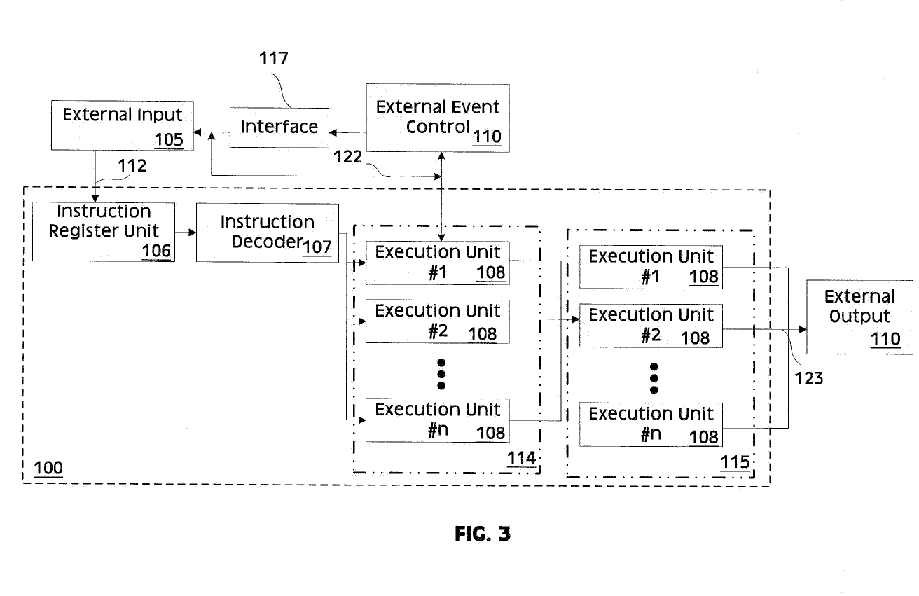

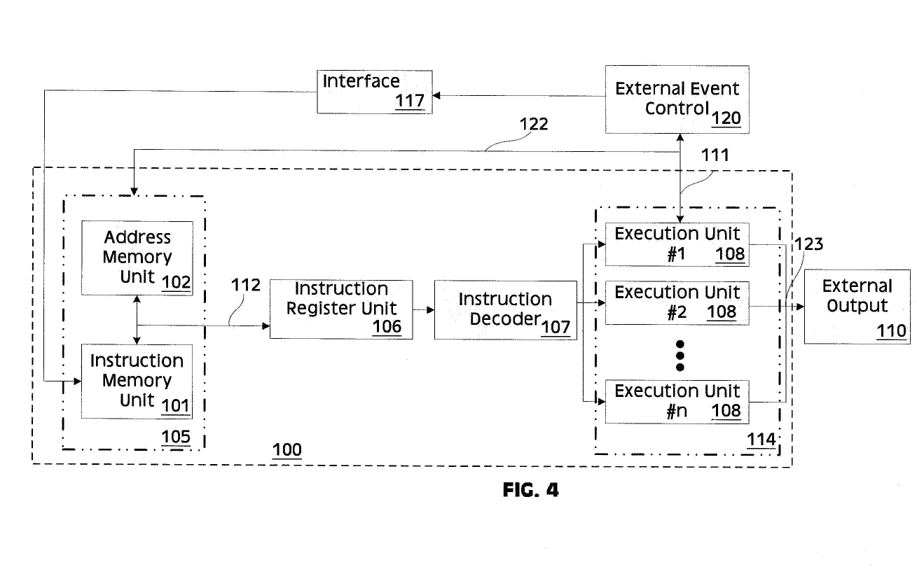

As illustrated by FIG. 3, the MXFP 100 can also include additional stages of execution units 115. Once the first stage of execution units 114 completes an operation, it can pass off the output of the first stage 114 into another stage 115 to continue the operation. This configuration provides additional flexibility to the design of the MXFP 100, as it enables a data memory access operation to be broken down into even smaller executable parts, thereby enabling the operation to be completed with greater speed.

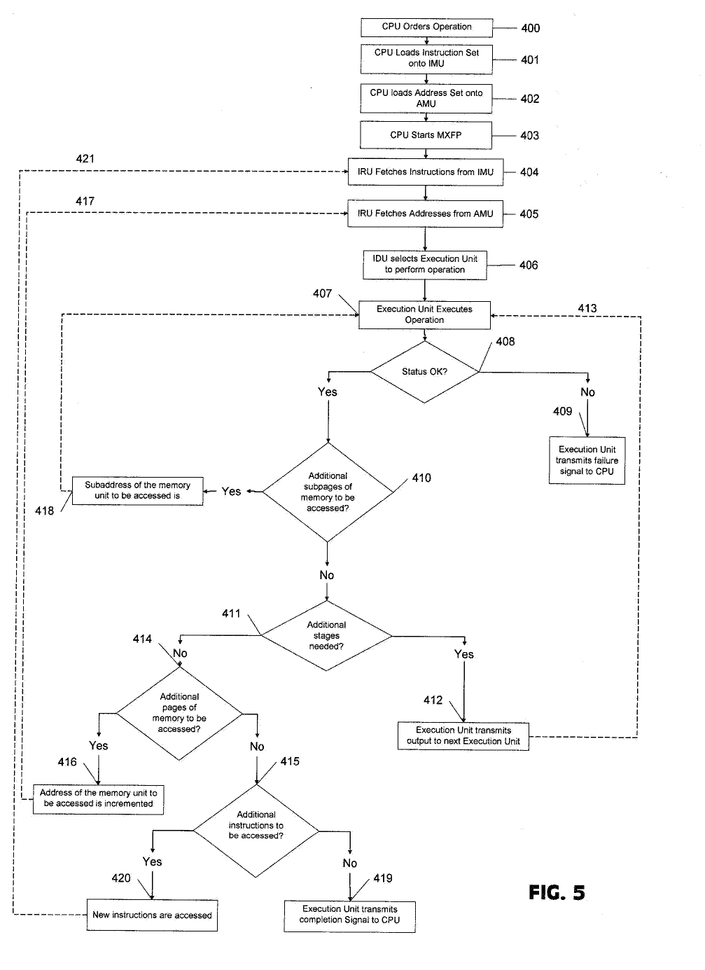

An additional embodiment is illustrated in FIG. 4, where the input 105, comprising the IMU 101 and AMU 102, can be located inside the MXFP 100. In such an embodiment, the execution units 108 can communicate directly with the IMU 101 and AMU 102 through transmission line 122.

The method of performing a data memory access operation with the MXFP 100 is illustrated in FIG. 5. As illustrated in block 400, the operation begins with the CPU ordering the operation, whereby the CPU 113 then loads the relevant TPISs and addresses on to the IMU and AMU, as illustrated in blocks 401 and 402, respectively. As is illustrated in block 403, once the instruction sets and addresses are loaded, the CPU will then start the MXFP, whereupon the IRU will fetch the relevant instructions and addresses from the input that includes the IMU and AMU, as shown in block 404. The IDU will interpret the instruction and address data, as shown in block 406; if the operation needs to be split into smaller individual operations, the IDU will select execution units to each execute one of those smaller operations.

If additional operations need to be performed, the IDU can select execution units to perform those operations. For example, if the execution units will be operating on an event basis, independent of a specific number of clock cycles, the IDU may order an execution unit to detect when each other execution unit finishes its operation and then transmit a signal when all other execution units have finished their respective operations. Should an execution unit fail to execute its operation successfully, for example if the operation was performed incorrectly), the execution unit can transmit a failure signal to the CPU, as shown in block 409. Otherwise, the execution unit will continue, as shown in block 408.

If additional sub operations (for example, writing to additional sub-addresses) need to be executed by the execution unit, as shown in block 410, the execution unit will continue on a loop, illustrated in block 418, until no further sub-operations are required. If the outputs of the first execution unit stage must be transmitted to additional stages, the sub-operation loop illustrated by loop 413 will continue until all execution units in all stages have completed their operations. At this point, if additional full addresses of the NVSM banks need to be accessed, as illustrated by block 414, the NVSM address will be incremented, and the operation will cycle again through the execution unit stages, as illustrated by loop 417. Once all required NVSM bank addresses have been accessed, the MXFP can continue on a loop until there are no further instructions to execute, as shown by loop 421, at which time an execution unit can be ordered to transmit a signal to the CPU indicating that the requested operation has been completed, as shown by block 419.

As may be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item.

The descriptions used herein are set forth by way of illustration only and are not meant as limitations; instead, the invention is defined by the appended claims. Various embodiments of the claimed invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

Some embodiments of the claimed invention have also been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

A reference to an element in the singular is not intended to mean “one and only one” unless specifically stated, but rather “one or more.” The term “some” refers to one or more. Underlined and/or italicized headings and subheadings are used for convenience only, do not limit the claimed invention, and are not referred to in connection with the interpretation of the description of the invention. In addition, the description of a signal being sent over a transmission line does not limit the claimed invention to that sole means of transmission. Moreover, nothing disclosed herein is intended to be dedicated to the public regardless of whether such disclosure is explicitly recited in the above description.

What is claimed is:

1. A processing core, comprising:
an instruction register unit operable to fetch instructions stored in an instruction memory, wherein each of the instructions requires a number of clock cycles to complete;
an instruction decoder unit coupled to the instruction register unit and operable to provide each of the instructions to an execution unit;
a plurality of execution units configured to perform operations associated with accessing non-volatile semiconductor memory units;
at least one of the plurality of execution units operable to execute instructions requiring different numbers of clock cycles to complete; and
the at least one of the plurality of execution units further operable to generate an event control signal in response to the at least one execution unit completing execution of an instruction.

2. The processing core of claim 1, further comprising:
an instruction memory unit coupled to the instruction register unit, wherein a size of the instruction memory used for an instruction is variable depending on the operation associated with the instruction.

3. The processing core of claim 2, further comprising:
the instruction memory unit capable of being programmed post-manufacture to include Tightly Packed Instruction Sets configured for use with different numbers of flash memory units.

4. The processing core of claim 1, further comprising:
an address memory unit coupled to the instruction decoder unit, the address memory unit programmable to store a variable number of addresses of a plurality of nonvolatile semiconductor based memory unit.

5. The processing core of claim 1, further comprising a plurality of execution unit stages, the plurality of execution unit stages comprising:
first stage execution units to execute a first operation associated with a selected instruction; and
second stage execution units to execute a second operation of the selected instruction.

6. The processing core of claim 5, further comprising:
the selected instruction including an operand specifying which of the second stage execution units to use to execute the second portion of the selected instruction.

7. The processing core of claim 1, wherein the instructions stored in the instruction memory comprise:
an application-specific instruction set to be executed by the plurality of execution units, the instruction set including instructions having variably sized opcodes and operands.

8. The processing core of claim 7, wherein a particular instruction controls a particular execution unit in multiple ways.

9. The processing core of claim 1, further comprising:
an execution unit configured to operate on an event basis, independent of a number of clock cycles.

10. The processing core of claim 1, further comprising:
the processing core configured to transmit a plurality of commands and addresses to the nonvolatile semiconductor-based memory banks, the commands comprising:
both atomic and separate commands.

11. A solid state drive controller for use with nonvolatile semiconductor based memories, the solid state drive controller comprising:
a first processor core;
at least one second processor core controlled by the first processor core, configured to respond to memory access commands issued by the first processor core, and configured to control access to at least one nonvolatile semiconductor based memory unit;
an interface coupling the second processor core to the at least one nonvolatile semiconductor based memory;
the second processor core configured to execute memory access instructions on an event-driven basis, independent of a specific number of clock cycles used by the instructions.

12. The Solid State Drive Controller of claim 11, wherein the First Processing Core is configured to direct the Second Processing Core to access and control a NAND Flash memory unit.

13. The Solid State Drive Controller of claim 11, further comprising:
an instruction memory unit coupled to the second processor core, wherein a size of the instruction memory used for an instruction is variable depending on an operation associated with the instruction.

14. The Solid State Drive Controller of claim 11, further comprising:
an address memory unit coupled to the Multi-Execution Flash Processor Core, the address memory unit programmable to store a variable number of addresses of the nonvolatile semiconductor based memory units.

15. A method comprising:
loading into an instruction memory unit a set of instructions configured to perform a memory access operation on a bank of solid state nonvolatile semiconductor based memories;
fetching from the instruction memory unit an instruction from the set of instructions;
using an instruction decoder unit to select a first execution unit to perform at least one part of an operation associated with the instruction;
executing at least a first part of the instruction using the first execution unit, wherein executing the at least a first part of the instruction includes selecting a second execution unit to execute at least a second part of the instruction; and
generating an event control signal upon completion of the operation associated with the instruction.

16. The method of claim 15, further comprising:
transmitting, from one of the first execution unit and the second execution unit to the central processing unit, a signal indicating completion of the operation.

17. The method of claim 15, further comprising:
transmitting an operation output from the first execution unit to another stage of at least one execution unit to complete an additional operation.

18. The method of claim 15, further comprising:
using the set of instructions to reprogram the instruction memory unit with new instructions.

19. The method of claim 15, further comprising:
executing a plurality of second parts of the instruction in a plurality of second execution units in parallel.

20. The method of claim 15, wherein a single instruction from the set of instructions can control a single execution unit in multiple ways.

21. The method of claim 15, wherein the first and second execution units are configured to operate on an event basis, independent of a number of clock cycles.

22. The method of claim 15, further comprising:
combining a plurality of instruction sets to form a plurality of action sequences that can be communicated to the nonvolatile semiconductor-based memory banks.

23. The method of claim 15, wherein an execution unit changes the contents of the address memory unit.
